(19) United States
(12) Patent Application Publication
(10) Pub. No.: US 2016/0309032 A1
(43) Pub. Date: Oct. 20, 2016

(54) ENHANCING CALL EXPERIENCES THROUGH PERSONAL RULES

(71) Applicant: Interactive Intelligence Group, Inc., Indianapolis, IN (US)

(72) Inventors: Kalpit Patel, Cary, NC (US); Richard J. Walsh, Raleigh, NC (US); Richard M. Neidermyer, Lititz, PA (US)

(73) Assignee: INTERACTIVE INTELLIGENCE, INC., INDIANAPOLIS, IN (US)

(21) Appl. No.: 14/688,610

(22) Filed: Apr. 16, 2015

(51) Int. Cl. H04M 3/523; H04M 3/51; H04M 3/42

(52) U.S. Cl. CPC H04M 3/5235; H04M 3/42059; H04M 3/5166; H04M 3/5191

(57) ABSTRACT

Methods for enhancing call experiences through personal rules are provided. In one example, a method includes the steps of receiving a phone call and caller identification information associated with the phone call and routing the phone call to an interactive voice response system. A caller profile is developed based on a comparison of the caller identification information and one or more data stores. The caller profile is matched with a predetermined personal rule, and a dynamic message is generated in the interactive voice response system based on the matching predetermined personal rule.

### FIELD

This invention relates generally to contact centers, and more specifically to enhancing call experiences through personal rules.

### BACKGROUND

In conventional contact centers, every call may be handled in a uniform manner, such as in the order in which each call is received. During normal business hours, when a call is received a call may automatically be routed to the shortest queue at the time in which the call is received. Calls may alternatively be routed into an interactive voice response (IVR) system. Such IVR systems may present every caller with the same uniform menu of options.

By treating every caller in a singular, unified manner, many important calls may be lost, while less important calls may unnecessarily use up valuable resources. Thus there is a need for new methods to handle callers in a contact center.

### SUMMARY

Embodiments of the invention retain calls through personal rules. An exemplary method may comprise the steps of receiving a phone call and caller identification information associated with the phone call, routing the phone call to an interactive voice response system, and developing a caller profile based on a comparison of the caller identification information and one or more data stores. The method comprises the additional steps of matching the caller profile with a predetermined personal rule and generating a dynamic message in the interactive voice response system based on the matching predetermined personal rule.

In another aspect, a method comprises the steps of receiving an incoming communication and identification information associated with the incoming communication, routing the incoming communication, developing a profile based on the identification information, matching the profile with a predetermined personal rule, and generating a dynamic message in the interactive voice response system based at least in part on the profile and the matching predetermined personal rule.

In another aspect, a method comprises the steps of receiving an incoming communication and identification information associated with the incoming communication, developing a profile associated with the incoming communication, and matching the profile with a predetermined personal rule. The method includes the additional step of generating a dynamic out-of-band response based on the matching predetermined personal rule.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, serve to explain the principles of the invention and to enable a person skilled in the pertinent art to make and use the invention.

FIG. 1 is a flow chart illustrating a method according to an embodiment.

FIG. 2 is a flow chart illustrating a method according to another embodiment.

FIG. 3 is a flow chart illustrating a method according to another embodiment.

FIG. 4 is a diagram illustrating a system according to an embodiment.

### DETAILED DESCRIPTION

Embodiments are described for enhancing call experiences through personal rules. Predetermined personal rules may be used to dynamically route calls and generate dynamic responses according to one or more parameters, such as who is calling, the availability of an agent for accepting the call, who the agent is, a ranking of the call, or even a prediction of the issue that a caller is facing. By using personal rules to enhance call experiences, organizations can tailor the call experience for each caller, make better use of their limited resources, and prioritize the most important calls.

In one exemplary embodiment a small business may utilize a contact center system for managing phone calls and interacting with callers. In contrast to large organizations with call centers comprising tens or hundreds of agents, a small business may have particularly limited resources for answering phone calls. The few employees tasked with handling calls may also be tasked with other simultaneous responsibilities, such as office management or accounting.

In the example, an incoming phone call and caller identification information in the form of caller ID, is received by a contact center system operated by the small business. The phone call may be routed to an interactive voice response system and a caller profile may be developed based on the caller ID. The caller profile may be developed by finding records associated with the caller ID in one or more data stores, such as an internally maintained Customer Relationship Management (CRM) database or an external social media feed (e.g. Twitter, Facebook, Instagram, etc.). A caller profile may comprise information about the caller, such as the caller's name, phone number, interactions with the company, status, and recent activity.

Individual users of the contact center system, such as a contact center administrator or a contact center agent, may predefine one or more personal rules for managing phone calls. A personal rule may specify a target or targets, such as a specific group of people, and a response or action to perform for calls from that target. In the example, a caller profile is developed and matched to a predetermined personal rule by matching the caller profile with a target of a personal rule.

Finally, after the caller profile is matched to a predetermined personal rule, a dynamic response may be generated. One form of dynamic response may comprise a dynamic routing of a call. One matching personal rule may specify that any calls from that specific person, or target, be routed into an IVR system. A related personal rule may specify that any calls from all other targets be routed to voice mail. Another form of dynamic response may comprise a message, such as a message in the interactive voice response system based on the matching predetermined personal rule. One type of dynamic message may comprise a menu option in the IVR.

In the example a caller profile is matched with a personal rule stipulating that a call be routed to an IVR, and that a dynamic message comprising a discount code be generated in the IVR. By applying targeting personal rules to individual calls, businesses and organizations can prioritize contact center resources and enhance call experiences.

### Illustrated Methods

Selected methods are illustrated and described for enhancing call experiences through personal rules. By using personal rules, businesses with limited resources for handling calls may specify how individual calls may be managed. For example, high priority callers may be retained and routed through an IVR, while low priority callers may be routed to voice mail. By enhancing call experiences through personal rules, contact center resources may be maximized and directed towards the highest priority targets.

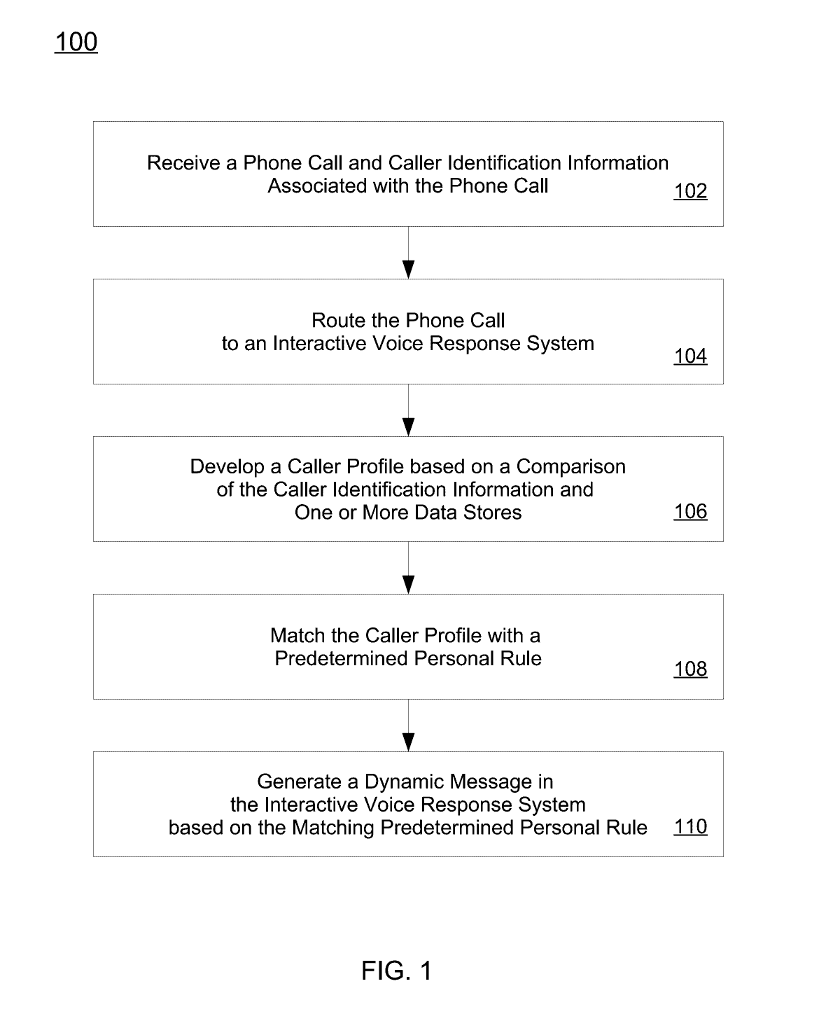

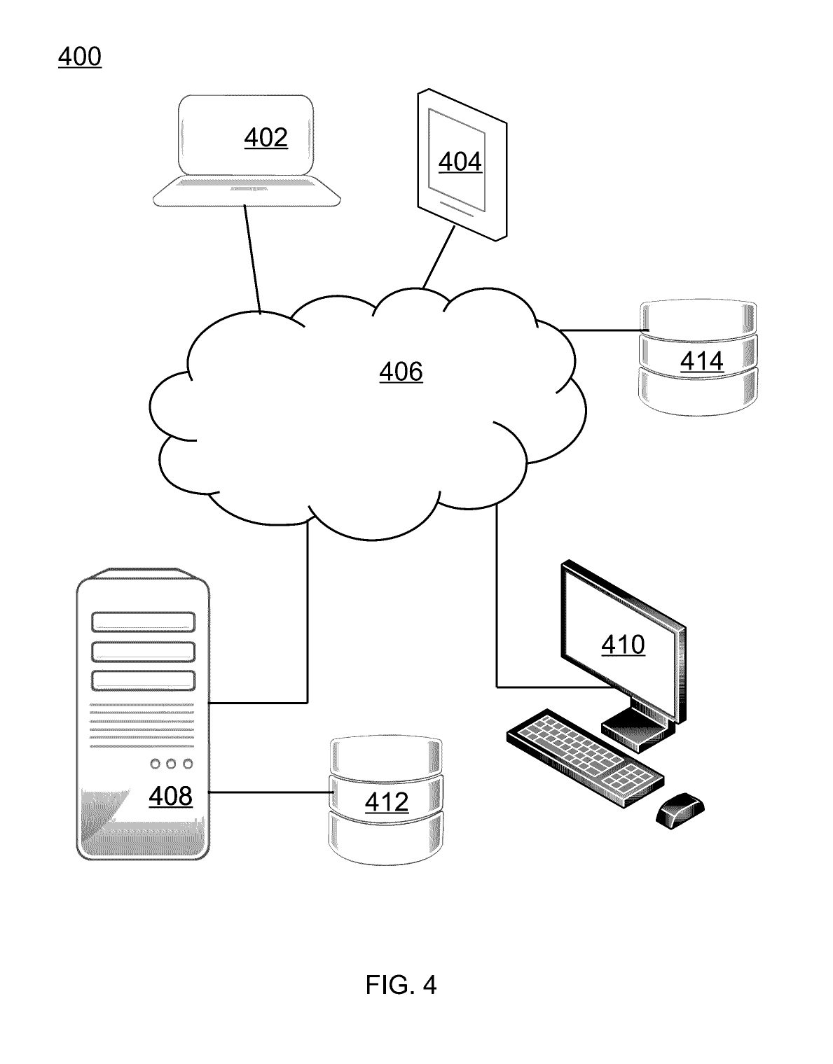

FIG. 1 is a flow chart illustrating a method according to an embodiment. As shown in FIG. 1, in step 102 of method 100, a phone call and caller identification associated with the phone call may be received. A server, such as server 408 as illustrated in FIG. 4 and discussed below, may receive the phone call and caller identification information. A phone call, sometimes referred to as a voice call, may be received over a traditional telephone line (e.g. plain old telephone service, or POTS), or it may be received over an internet telephony service such as VOIP, WebRTC, or a similar technology.

A caller may refer to a person that causes a device, such as a smartphone, limited capability phone (e.g. “feature phone”), tablet, personal computer, or other device to call or transmit a communication over a network. Examples of devices configured to generate a call are illustrated, without limitation, in FIG. 4 and described below. In the embodiment illustrated in FIG. 1, a caller may cause a phone call to be generated. In other embodiments, a caller may cause some other type of communication to be generated, such as a video call or instant message chat.

Caller identification information may comprise information associated with the party causing a call to be generated. Caller identification information may exactly identify a caller, or identify one or more aspects associated with the caller. In one embodiment, caller identification information comprises Caller ID. Caller ID may transmit a caller's number and/or a name associated with the calling number. Caller ID may sometimes be referred to as caller identification, CID, calling line identification (CLD), calling number delivery (CND), calling number identification (CNID), or calling line identification presentation (CLIP). Caller ID may be a phone service, available in analog and digital phone systems, including voice over Internet Protocol (VOIP). In another embodiment, caller identification information may comprise meta information transmitted along with a call, such as a username, internet provider, or email address.

Caller identification information may comprise information associated with the device generating the call. Caller identification information may exactly identify a calling device, or identify one or more aspects associated with the calling device. For example, caller identification information may comprise an IP address, G.P.S. coordinates, software information (e.g. an operating system, software version number), or a device type. Other caller identification may comprise more general identification information, such as an internet service provider, or a general location, i.e. a neighborhood, city, or area code.

In step 104 the phone call may be routed to an interactive voice response system. An IVR system may allow a caller, such as a customer, to interact with a computer, such as server 408, through voice, keypad, and/or keyboard input during a voice call, video call, or instant message chat. The IVR system may utilize speech recognition, text-to-speech, and speech-to-text to interact with a caller. In other embodiments, a phone call may be routed to an Automated Call Distributor (ACD) queue, a voice mail system, or a contact center station. In one scenario, a call may be automatically routed to a contact center station when a contact center agent is available. This routing may occur due to a default personal rule specifying that any call be routed to a contact center station if the status of the contact center agent associated with the contact center station is available.

In step 106, a caller profile may be developed based on a comparison of the caller identification information and one or more data stores. When caller identification information is received, the system may check one or more data stores for any caller profiles associated with the caller identification information. In one embodiment, developing a caller profile comprises creating a new caller profile. In one scenario, a new caller profile may be created upon the first time a caller calls an organization. A caller may be categorized as a new caller when caller identification information associated with the call, such as caller ID number, I.P. address, or a geographic location, is not found in any data stores. In another embodiment, developing a caller profile comprises updating an existing caller profile. In the case of a repeat caller, caller identification such as caller ID number, I.P. address, or geographic location may be associated with an existing record in a caller profile data store.

In one embodiment, a caller profile may be developed, at least in part, by accessing an internal data source. In the embodiment, the contact center system may match caller identification information in the form of a phone number with one or more records stored by an internal data store. An internal data store may comprise a private data store accessible only to authorized users of an organization, such as a CRM database. A matching record in the CRM database may comprise one or more data fields associated with one or more types of identification information. Examples of data fields in a CRM database comprise, without limitation, a name, email address, phone number, social media handle, customer order history, product history, service history, contact history, and social media activity. One or more data fields in an internal store may be matched with the identification information. A caller profile based on a match may comprise one or more of the data fields in the internal data store. One or more data stores may be accessed to build a caller profile.

An existing or newly created caller profile may be used to predict an issue associated with the person's present call. A caller profile may comprise information gathered from one or more data stores. In one embodiment, a caller profile comprises a customer order history. When a customer calls a business shortly after ordering a product, the system may predict that a caller is interested in their order history or tracking their order. In another embodiment, a caller profile comprises social media information collected from one or more external data stores. A caller may have an active Twitter feed, for example, comprising numerous complaints or praises related to the organization being called.

A caller profile may be used to generate a ranking associated with the phone call. A call may be ranked based on one or more parameters, such as and without limitation, the identity of the caller, the location of the caller, or the call history of the caller. In one example, a business may prioritize new customers over existing customers. In this example, a business may generate a lower ranking for a repeat caller, and a higher ranking for a new caller.

A ranking may be generated by accessing one or more of an internal data source and an external data source. In one embodiment, a ranking may be based on the amount of social network activity associated with the caller profile. A caller profile associated with a high frequency of social network messages, or a large number of followers on one or more social networks, may be ranked higher than a caller profile associated with a low frequency of social network messages or a low number of followers on one or more social networks.

In step 108, the caller profile may be matched with a predetermined personal rule. A personal rule may specify how to manage an incoming communication such as a phone call. A personal rule may be a function of a target evaluated against a caller profile. As one example a personal rule may specify that a dynamic response to be generated for any calls from a target, such as a specific person or a specific group of people. As another example, a personal rule may specify that a dynamic response be generated for a caller profile comprising a ranking exceeding a predetermined threshold.

A personal rule may be a function of a condition evaluated against a caller profile. In one embodiment, a personal rule may specify that a dynamic response be generated after a condition is met. A condition may comprise, for example, a predetermined wait time in an ACD queue, or a predetermined number of calls into the system. In one example, an incoming communication may be routed to an ACD queue. A personal rule may specify that if a caller waits longer than five minutes in the ACD queue that a dynamic response be generated, such as an email with a discount code, or a conciliatory message played over the phone.

In one example, when an agent is available to accept calls, all calls may be routed to the available agent. When no agent is available to accept calls, a personal rule may specify that a dynamic response be generated. In the example, the personal rule may specify that a dynamic message may be generated for any calls routed to an IVR while an agent is unavailable.

A personal rule may be specified, or predetermined, before a communication is received. An individual user, such as a contact center administrator or a contact center agent, may predetermine one or more personal rules for managing incoming communications.

A personal rule may comprise one or more parameters for managing a call. Examples of parameters associated with a personal rule (i.e. personal rule parameters) comprise, without limitation, a target of the personal rule, a status of an agent, an evaluation of an aspect of the caller profile, and an action to be performed in the case of a match with an incoming phone call.

One parameter associated with a personal rule may comprise a target of the personal rule. A target may comprise a caller or group of callers covered by a personal rule. A target may comprise a specific person, or one or more people associated with a characteristic. For example, the target of one personal rule may comprise any member of an organization. A target may comprise a class of people, such as every person in a particular demographic, such as college students or seniors. After a profile is developed, the profile may be matched with a personal rule by matching the name, or identity of a profile with the target of a personal rule.

Another parameter associated with a personal rule may comprise the status of an agent. An agent may be online and available, online and busy, or offline. When an agent logs on and off a contact center system, their status may automatically be updated. One set of personal rules may apply for an agent who is online, and another set of personal rules may apply for an agent who is offline. Similarly, one set of personal rules may apply for an agent who is available, while another set of personal rules may apply for an agent who is busy. As an example, an agent may have a personal rule specifying that all calls be routed to the agent while the agent is available, and that only certain calls be routed to an agent, such as through call waiting, when an agent is busy.

Another parameter associated with a personal rule may comprise an evaluation of aspect of the caller profile. For example, a set of personal rules may apply to an evaluation of a ranking of a caller profile. In the example, all caller profiles associated with a higher ranking may be treated in a first manner, and all caller profiles associated with a lower ranking may be treated in a second manner.

Another parameter associated with a personal rule may comprise an action to be performed. An action may comprise, for example and without limitation, routing a call, re-routing a call, a dynamic message generated on an IVR, or a dynamic out-of-band message.

In one example, an agent may predefine two personal rules. The first personal rule may specify that all caller profiles with a ranking exceeding a predetermined threshold may be accorded a first response. The second personal rule may specify that all caller profiles with rankings not exceeding the predetermined threshold may be accorded a second response. All caller profiles associated with a high ranking may be routed to a contact center agent queue with the shortest wait time or the highest call satisfaction rate. All caller profiles associated with a low ranking may be routed to a voice mail system.

In step 110, a dynamic message may be generated in the interactive voice response system based on the matching predetermined personal rule. The dynamic message may be generated based on an analysis of the caller profile and an application of a personal rule. In contrast to a static message, which may be predetermined and generated to every caller, a dynamic message may be generated after developing a caller profile and matching the caller profile with a predetermined personal rule.

A dynamic message may be generated based at least in part on a predicted issue. For example, information developed in a caller profile from one or more data stores may suggest that a customer is seeking support for a recently purchased device. An order history associated with the caller identification information, and the customer, may comprise a specific product. Additionally, the customer may have mentioned an issue with the product on a public data store, such as a Facebook post. A dynamic message generated in an IVR may mention this product specifically, and offer one or more tips or solutions to the predicted issue. The call may also be dynamically routed to an agent that is more familiar with this product.

A dynamic message may be generated based at least in part on a ranking associated with the phone call. In one example, a coupon code, or discount code, may be generated in the case that a ranking associated with a caller profile exceeds a predetermined threshold. The coupon code may not be generated in the case that the ranking associated with the caller profile does not exceed a predetermined threshold.

A dynamic message may comprise an in-band message or out-of-band message. An in-band response, such as an in-band message, may comprise a response generated over the same communications medium as the original incoming communication. In the embodiment illustrated in FIG. 1, the original incoming communication comprises a phone call. A dynamic message generated in the IVR system may be played, or output, over the same voice communication, thus comprising an in-band message.

In another embodiment, an out-of-band response may be generated. An out-of-band response may comprise a response generated over a different communication type than the original incoming communication. For example, in the scenario illustrated in FIG. 1, an incoming communication comprises a phone call. An out-of-band response may comprise a response generated over a different type of communication, such as email or social media. Examples of dynamic messages comprise, without limitation, an SMS message, email, Twitter message (aka tweet), or Facebook post

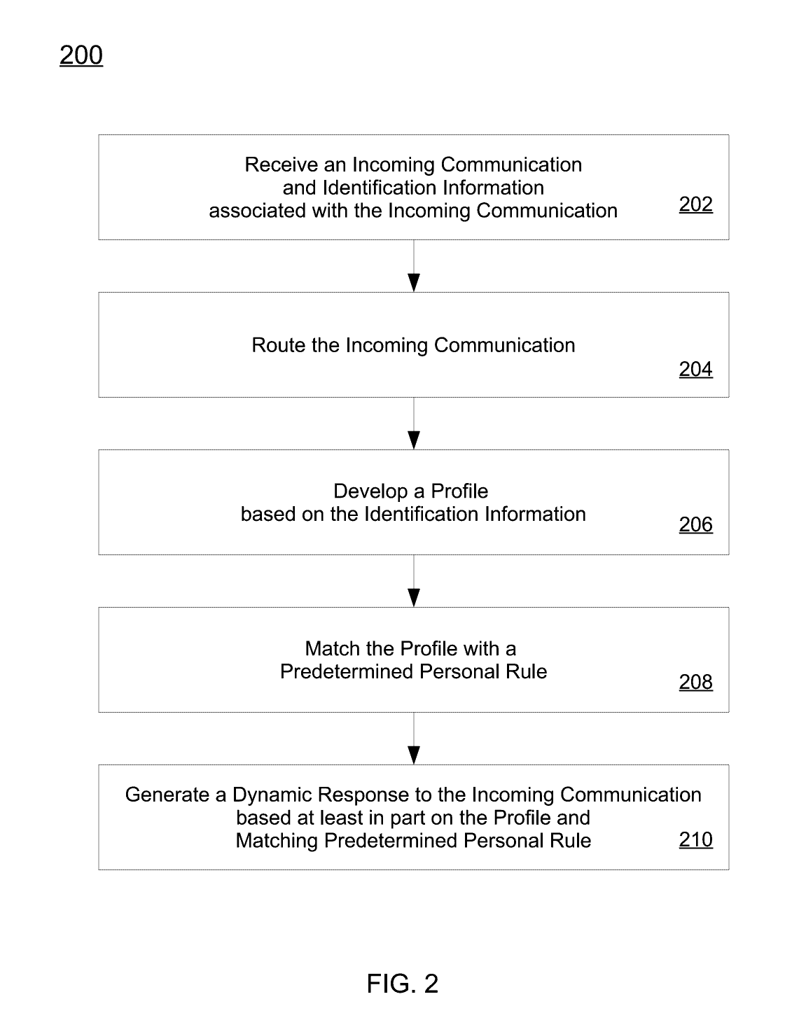

FIG. 2 is a flow chart illustrating. a method according to another embodiment. As illustrated in FIG. 2, in step 202 of method 200, an incoming communication and identification information associated with the incoming communication may be received. The incoming communication may be a phone call (i.e. a voice call). In other embodiments, the incoming communication may be a video call or an instant message chat. The incoming communication may be received by a contact center system operating on a server, such as server 408 as illustrated in FIG. 4 and described below.

In one embodiment, an incoming communication may comprise an active or open and ongoing communication channel, such as a voice call, video chat, or instant message chat. In another embodiment, an incoming communication may comprise a passive communication channel, such as an email message, SMS text message, or social media post (e.g. a social media message mentioning the business or organization).

As illustrated in FIG. 2, identification information may be received with an incoming communication. Identification information may comprise, for example and without limitation, caller ID, an IP address, or G.P.S. coordinates. In one embodiment, a phone call and caller ID is received. Caller ID may identify a phone number associated with a device, such as a phone, generating the incoming communication. An IP address may identify the Internet Protocol address of a device generating an incoming communication. G.P.S. coordinates may identify the location of a device generating an incoming communication.

In step 204, the incoming communication may be routed. The incoming communication may be routed to an interactive voice response system, an automated call distributor (ACD) queue, a voice mail system, or a contact center station. In one embodiment, an incoming communication may be routed initially to an IVR system, and routed a second time after a caller profile is matched with a predetermined personal rule. The IVR may generate a welcome message to initial callers while the caller identification information is analyzed, the caller profile is developed, and a predetermined personal rule is matched with the caller profile.

In step 206 a profile associated with the incoming communication may be developed. The profile may be developed by accessing one or more data stores and comparing the identification information associated with the incoming communication with the one or more data stores. Developing a profile may comprise creating a new profile or accessing an existing profile. In the case of an existing profile, developing a profile may comprise updating the existing profile.

Identification information received by the system, such as caller ID, an IP address, G.P.S. coordinates, a username, or an email address, may be used to identify a person causing an incoming communication. In one embodiment, a phone call number is matched in a CRM database with an existing customer profile.

A profile may be updated independent of an incoming communication. By updating a profile independent of an incoming communication, predetermined personal rules may be even more effective. In one example, a profile is updated as information is collected from an external data store, such as a social media feed. As a customer posts a social media message and mentions an organization or product, a profile of the customer may be updated.

In step 208, the profile may be matched with a predetermined personal rule. A predetermined personal rule may specify a target. In one embodiment a profile may be matched with a predetermined personal rule by matching an aspect of the profile, such as the name, customer number, or phone number of the profile with a target of a predetermined personal rule. A target may comprise a person, or group of people, which the personal rule applies to. The target may comprise a specific person, or a class of people, such as callers with a ranking higher than a predetermined value.

In step 210 a dynamic response may be generated based at least in part on the matching predetermined personal rule. In contrast to a static response, which may be predetermined and generated to every caller, a dynamic response may be generated after developing a caller profile and matching the caller profile with a predetermined personal rule.

A dynamic response may comprise an action. In one embodiment, an action comprises routing a phone call. A phone call may be routed to an IVR, an ACD queue, a voice mail, or a different number, such as a cell phone. In another embodiment, an action comprises transforming a voice call to a speech-to-text/text-to-speech interaction.

A dynamic response may comprise generating a message. Examples of dynamic messages comprise, without limitation, a message generated in an IVR system, an email message, or a social media post. A dynamic message generated in an IVR may comprise an interactive message, such as a routing choice in an IVR. In one example, a caller profile comprises a plurality of complaints published by a caller on the social media network Twitter. A matching personal rule may specify one or more routing choices in the IVR, for example “We noticed your twitter complaints. Press 1 to talk us about your power cord issues, Press 2 to talk with us about your device issues, or Press 3 to talk with us about your bill.”

A dynamic message may be generated and transmitted to a caller based on information in the caller profile or in one or more data stores. In one example, a caller places a voice call into a system. The system may use the caller identification to determine an email address of the caller, and after the call is completed, email the caller. By using caller identification information or information in a caller profile, a business may avoid repetitive conversations with callers to determine information that might otherwise be readily available to the business. This may save both the caller and the company time and effort, increasing overall satisfaction with the business.

A dynamic response may comprise an in-band dynamic response or an out-of-band dynamic response. An in-band response may comprise a response generated within the same communication as the incoming communication. For example, when a voice call is received, an in-band response may comprise a response generated on the voice call, such as a message on an IVR the voice call is routed to. An out-of-band response may comprise a response generated outside the same communication as the incoming communication. For example, when a voice call is received, an out-of-band response may comprise an email, text message, or social media post.

An out-of-band response may be associated with an external data store, such a social network. For example, a personal rule may specify that a message may be generated on a social network in response to a call that cannot be immediately answered.

In one embodiment, a dynamic response may comprise dynamic routing of the call. For example, a personal rule may stipulate that a call associated with a ranking exceeding a predetermined threshold be automatically routed to a specific contact center station, such as a cellular phone. In this manner a business may always receive important, or highly ranked calls, even outside of normal business hours. A corresponding personal rule may stipulate that a call associated with a ranking not exceeding the predetermined threshold be automatically routed to voice mail, or in one alternative, to an IVR system.

A dynamic response may be generated while the incoming communication is active, or in one alternative, after a predetermined delay. A delayed dynamic response (i.e. a dynamic response generated after a predetermined delay) may occur while an incoming communication is still active, or in an alternative after the communication is finished. In one example, a dynamic response to an incoming voice call comprises an email including a “thank you” note and a discount code. The dynamic response may be generated thirty minutes after the incoming communication is completed, or ends. By delaying a dynamic response, an overall customer experience may be enhanced by reinforcing a positive interaction at a later time.

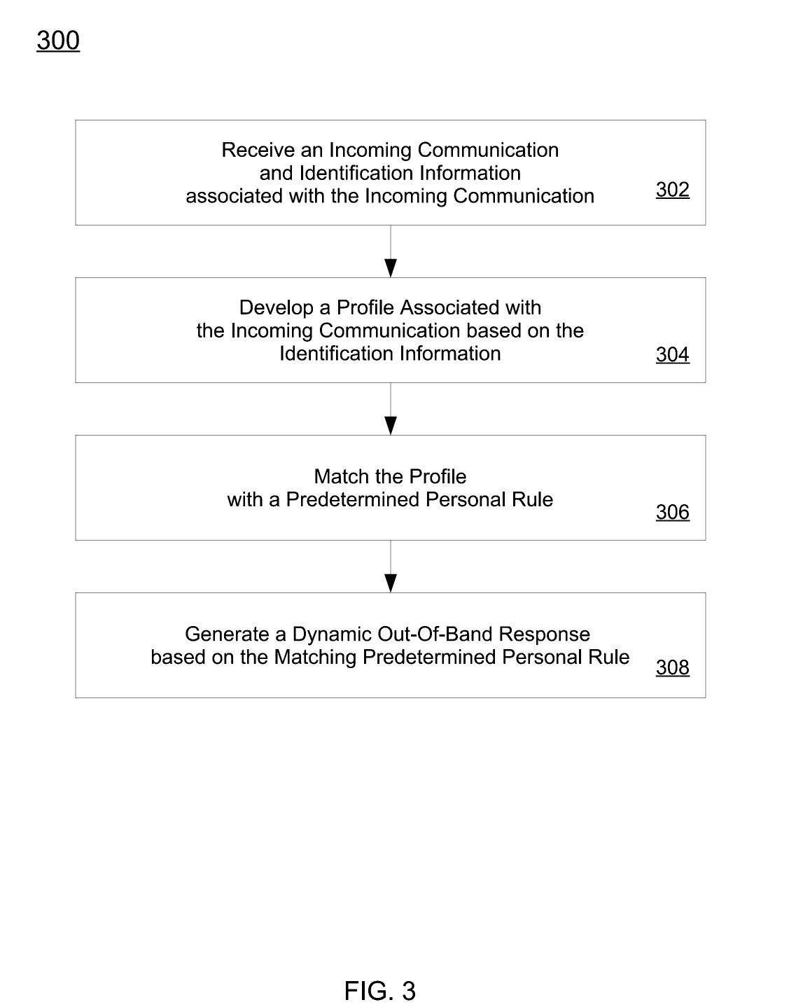

FIG. 3 is a flow chart illustrating a method according to another embodiment. As illustrated in FIG. 3, in step 302 of method 300, an incoming communication and identification information associated with the incoming communication may be received. An incoming communication may comprise a phone call, video call, or instant message chat. Identification information may comprise information closely or loosely associated with the identity of the caller. Identification information may comprise one or more of a caller's name, username, number, email address, ip address, street address, general location, area code, internet service provider, and/or some other type of identifying information.

In step 304, a profile associated with the incoming communication may be developed. The profile may be newly created, or in one alternative, updated from an existing caller profile. The profile may be developed by accessing one or more data stores, such as a private data store or a public data store, to find records matching the caller identification information.

In step 306, the profile may be matched with a predetermined personal rule. In one embodiment, after a profile is developed, the profile is matched with a predetermined personal rule. In one embodiment, a profile may match a plurality of personal rules. In this scenario a personal rule with the highest specificity, such as the smallest group of targets, may be matched with the profile.

In step 308, a dynamic out-of-band response may be generated based on the matching predetermined personal rule. The dynamic out-of-band response may be generated during the incoming communication, or in one alternative, after the incoming communication has ended. A dynamic out-of-band response may comprise a response on a communication channel different from the incoming communication channel. In one example, a voice call is received, and an out-of-band message comprises an email, text message, or social media post.

### Illustrated System

A small business or organization may operate a contact center system to handle incoming communications. Callers may generate incoming communications, such as voice calls, video calls, and instant message chats, to interact with another party, such as a representative of a business or organization. A contact center system may comprise a distribution center for routing incoming communications to one or more contact center stations.

One or more contact center agents, such as one or more employees of a small business, may interact with callers through the contact center system. A contact center agent may access the contact center system through a graphical user interface displayed on a contact center station. A contact center agent may engage in one or more conversations at the same time, for example, by instant message chatting with one caller while simultaneously talking with another caller. In a small business or organization, agents are often required to multi-task due to limited resources, and may even carry on other non-contact center related tasks while interacting with callers.

FIG. 4 is a diagram illustrating a system according to an embodiment. System 400 comprises client devices 402, 404, network 406, server 408, contact center station 410, internal data store 412, and external data store 414. Client devices 402, 404, server 408, contact center station 410, and external data store 414 may be in communication over network 406. Network 406 may comprise the Internet, an intranet, or extranet, or some other type of electronic network. Server 408 may be in direct communication with internal data store 412, or in communication with data store 412 over an internal network such as an intranet or a virtual private network.

Clients may comprise existing customers, prospective customers, partners, or third parties seeking to communicate with another party, such as a business or organization. Clients may use client devices, such as client devices 402, 404 to generate phone calls, video calls, instant message chats, or other forms of communication. Client devices may be configured to transmit identification information, such as caller ID, IP address, or location information, associated with the client device. Examples of client devices comprise, without limitation, a personal computer, tablet, smartphone, or a feature phone. As shown in FIG. 4, client device 402 comprises a personal computer 402, and client device 404 comprises a smartphone.

In one embodiment, a customer uses a smartphone 404 to communicate with a contact center system executing on server 408. Server 408 may be in communication with client devices 402, 404, data stores 412, 414, and contact center station 410. Server 408 may execute contact center software for facilitating communication between clients and agents over a network, such as customers using client devices 402, 404 and an agent using contact center station 410 over network 406. In one embodiment, an agent using contact center station 410 may access contact center software executing on server 408 over network 406.

Server 408 may receive incoming communications from client devices 402, 404. In one embodiment, an incoming communication may comprise an active or open and ongoing communication channel, such as a voice call, video chat, or instant message chat. In another embodiment, an incoming communication may comprise a passive communication channel, such as an email message or SMS text message. Server 408 may also receive identification information from client devices 402, 404. For example, Server 408 may receive caller ID, a caller's IP address, and/or a caller's G.P.S. location.

Server 408 may be in communication with one or more data stores, such as data store 412 and data store 414. A data store may store information about clients, contact center agents, and personal rules. A data store may be an internal data store, such as data store 412, or an external data store, such as data store 414. An internal data store may be in direct communication with server 408. An internal data store may be operated by the same organization operating server 408. In one embodiment, an internal data store comprises a CRM database. In other embodiments, internal data store 412 comprises other data stores. Server 408 may also be in communication with one or more external data stores, such as external data store 414. An external data store may not be operated by the same organization operating server 408. Sever 408 may interact with an external data store as a third party. An external data store may comprise a social media feed, such as a Facebook feed, Twitter feed, Vine feed, or Instagram feed.

Server 408 may generate a caller profile based on a comparison of caller identification information and one or more data stores.

Server 408 may match a caller profile with a predetermined personal rule.

A contact center station may comprise a network enabled device configured to execute contact center software and communicate with server 408 over network 406. Examples of contact center stations comprise a personal computer, such as personal computer 410, or a mobile device. A contact center station in the form of a mobile device may comprise a smartphone, e-reader, phablet, or a tablet. In other embodiments, a contact center station may comprise other types of devices. Contact center station 410 may be configured to generate a graphical user interface, and execute an application within the graphical user interface. Applications operating on client devices may comprise native mobile device applications such as an iOS iPad application, a Windows Phone application, or an Android application. As one alternative, an application operating on a client device may comprise a web application accessed through a web browser.

### Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

1. A method for enhancing call experiences through personal rules, the method comprising the steps of:
receiving a phone call and caller identification information associated with the phone call;
routing the phone call to an interactive voice response system;
developing a caller profile based on a comparison of the caller identification information and one or more data stores;
developing a caller profile comprising updating an existing caller profile if updates exist;
matching the caller profile with a predetermined personal rule; and
generating a dynamic message in the interactive voice response system based on the matching predetermined personal rule.

2.-20. (canceled)

21. A method for enhancing telecommunication through personal rules, the method comprising the steps of:
receiving an incoming communication and identification information associated with the incoming communication;
routing the incoming communication;
developing a profile based on at least one of:
(a) the identification information;
(b) one or more data stores;
developing a profile comprising the step of either:
(a) creating a new profile; or
(b) updating an existing profile if updates exist;
matching the profile with a predetermined personal rule;
generating a dynamic response to the incoming communication based at least in part on the matching predetermined personal rule.

22. The method of claim 21, wherein the incoming communication is a voice call.

23. The method of claim 21, wherein the incoming communication is a video call.

24. The method of claim 21, wherein the incoming communication is a text chat.

25. The method of claim 21, wherein the identification information comprises at least one of caller ID, IP address, G.P.S. coordinates, email address, and username.

26. The method of claim 21, wherein the incoming communication is routed to one of an interactive voice response system, an automated call distributor queue, a voice mail system, or a contact center station.

27. The method of claim 21, wherein developing a profile comprises accessing an internal data source.

28. The method of claim 21, further comprising predicting an issue associated with the incoming communication based on the developed profile.

29. The method of claim 28, wherein the dynamic response is generated based at least in part on the predicted issue.

30. The method of claim 21, further comprising generating a ranking associated with the incoming communication, and wherein the profile comprises the ranking.

31. The method of claim 30, wherein generating a ranking comprises accessing an internal data source and an external data source.

32. The method of claim 30, wherein the dynamic response is generated based at least in part on the ranking.

33. The method of claim 21, further comprising determining the incoming communication cannot be answered.

34. The method of claim 33, wherein determining the incoming communication cannot be answered comprises determining whether a queue has zero entries waiting.

35. The method of claim 21, wherein the dynamic response comprises an out-of-band response to the incoming communication.

36. The method of claim 35, wherein the out-of-band response comprises a response associated with an external data store.

37. The method of claim 36, wherein the external data store comprises a social media network.

38. The method of claim 35, wherein the dynamic response is generated after a predetermined delay.

39. A method for enhancing telecommunication experience through personal rules, the method comprising the steps of:
receiving an incoming communication and identification information associated with the incoming information;
developing a profile associated with the incoming communication based on the identification information;
matching the profile with a predetermined personal rule; and
generating a dynamic out-of-band response based on the matching predetermined personal rule.

40. The method of claim 39, wherein the incoming communication is a voice call.

41. The method of claim 39, wherein the incoming communication is a video call.

42. The method of claim 39, wherein the incoming communication is a text chat.
